(19) United States
(12) Patent Application Publication
(10) Pub. No.: US 2005/0103057 A1
(43) Pub. Date: May 19, 2005

(54) Method for making optical fiber preform having ultimately low pmd through improvement of ovality

(76) Inventors: Byung-Yoon Kang, Gyeonggi-do (KR); Joon-Ho Moon, Gyeonggi-do (KR); Bong-Hoon Lee, Gyeonggi-do (KR); Kyoung-Soon Park, Gyeongsangbuk-do (KR); Jun-Min Kim, Gyeongsangbuk-do (KR)

Correspondence Address: JONES DAY, 222 EAST 41ST ST, NEW YORK, NY, 10017, US

(21) Appl. No.: 10/495,474

(22) PCT Filed: May 28, 2003
(86) PCT No.: PCT/KR03/01050

(30) Foreign Application Priority Data
Sep. 3, 2002 (KR) 10-2002-0052791

(51) Int. Cl. C03B 37/018; C03B 37/012

(52) U.S. Cl. 65/391; 65/419

(57) ABSTRACT

A method for making an optical fiber preform having an ultimately low PMD (Polarization Mode Dispersion) through improvement of ovality is provided. This method has several collapse steps for collapsing an optical fiber preform having a clad/core deposition layer formed in a preform tube in which a rate of collapse is 0.01-0.06 mm/min at each collapsing step. By using this method, ovality and PMD of the optical fiber preform may be improved.

### TECHNICAL FIELD

The present invention relates to a method for making an optical fiber preform having an ultimately low PMD (Polarization Mode Dispersion) through improvement of the ovality of an optical fiber, and more particularly to a method for improving ovality and PMD of an optical fiber by optimizing a rate of collapse related to temperature, a movement velocity of a torch and a difference between inner and outer pressures of a hollow preform during the collapsing process.

In addition, the present invention relates to a method for improving PMD by keeping an inner diameter of a hollow preform in a constant value within the range of 2 to 4 mm just before closing the hollow preform through several times of collapsing processes, and then closing the hollow preform together with etching so that the refractive index dip phenomenon is minimized.

### BACKGROUND ART

Generally, an optical fiber broadly used as a waveguide for optical transmission is made by drawing a preform composed of a core and a clad at a high temperature.

A method for making an optical fiber preform is commonly classified into an outside deposition manner and an inside deposition manner, as well known in the art.

In case of the inside deposition manner, a soot generation gas such as SiCl₄, GeCl₄, POCl₃ is injected into a tube together with oxygen by means of a technique such as MCVD (Modified Chemical Vapor Deposition). Then, the tube is heated by a torch so as to cause deposition in the inner surface of the tube by way of thermal oxidation, thereby forming a clad and a core.

When the clad and the core are formed in the above process, a hollow portion exists in the tube. Thus, a collapsing process is further required for condensing the tube by applying heat to the clad and the core from outside.

The collapsing process is a very important process, which significantly affects on a geometric structure of the optical fiber preform. For example, if ovality of the tube 10, the core 1 and the clad 2 is not good as shown in a cross section of a preform in FIG. 1, PMD is increased and thus gives a bad influence on the optical transmission characteristic.

Considering that the ovality seriously depends on viscosity and surface tension of the heated hollow preform and the viscosity and surface tension are sensitively varied according to factors such as temperature, it is important to obtain optimal data of factors involved in the collapsing process in order to get sufficient ovality.

In addition, in the collapsing process mentioned above, the hollow preform in which deposition of the core is completed is heated at a temperature of 2000 to 2300° C. which is higher than that of the deposition process in order to decrease inner and outer diameters of the hollow preform. At that temperature, the inner and outer walls of the hollow preform reach a softening temperature at the same time, thereby generating viscous flow. At this time, it is known that the surface tension is generated toward a direction minimizing surface energy of the hollow preform and the viscous flow is also generated toward the inner circumference of the hollow preform due to the difference between inner and outer pressures of the hollow preform. As a result, considering that a rate of collapse is severely influenced by the difference between inner and outer pressures of the hollow preform as well as viscosity and surface tension of the heated hollow preform, and the viscosity and surface tension are sensitively varied according to the factors such as temperature, heating time, inner diameter and outer diameter, it is well understood that improvement of the ovality is closely related to a rate of collapse.

On the other hand, since the hollow preform in which deposition of the core is completed is heated at a temperature of 2000 to 2300° C. which is higher than that of the deposition process, volatilization of GeO₂, one of additives in the core, may occur.

Accordingly, the concentration of GeO₂ is decreased on the inner surface of the deposited core, thereby generating an index dip, i.e. a drop of the refractive index at the center of the core, as shown in FIG. 9. In addition, the volatilized GeO gas is sometimes condensed again into GeO₂ in front of the heat source and then dispersed into the core, so an index peak at which the refractive index rises up again at the core center may be generated.

The index dip and the index peak and resultant axial irregularity of the refractive index may deteriorate PMD due to the increase of loss caused by microbending and the potential stress caused by asymmetry of the refractive index in the single mode, and may significantly decrease a bandwidth in the multimode.

Thus, in order to etch such portions having a low refractive ratio, an etching process for flowing an etching gas such as C₂F₆, C₃F₈, C₄F₁₀ is progressed, and then a final collapsing process (hereinafter, referred to as “a closing process”) for eliminating inside holes to make a glass rod is executed to make an optical fiber preform.

However, volatilization of GeO₂ due to a high temperature may also occur in the closing process. Thus, an inner surface area of the hollow preform is preferably minimized just before the closing process in order to prevent the volatilization.

Despite minimizing the inner diameter of the hollow preform after the collapsing process however, the inner diameter is increased during the etching process due to internal hydraulic pressure, so it is still limited to minimize or prevent volatilization of GeO₂ in the closing process.

### DISCLOSURE OF INVENTION

The present invention is designed on the consideration of the above problems. Therefore, an object of the invention is to provide a collapsing method for improving ovality and PMD (Polarization Mode Dispersion) of an optical fiber by optimizing a rate of collapse related to a temperature of a hollow preform, a movement velocity of a torch and a difference between inner and outer pressures of a hollow preform.

In addition, another object of the invention is to provide a method for improving PMD by keeping an inner diameter of a hollow preform at a constant value within the range of 2 to 4 mm just before closing the hollow preform through several times of collapsing steps, and then closing the hollow preform together with etching so that the refractive index dip phenomenon is minimized.

In order to accomplish the above object, the present invention provides a method for improving ovality and PMD of an optical fiber by optimizing a rate of collapse of a hollow preform in a collapsing process wherein the collapsing process has several times of collapsing steps, and a rate of collapse at each collapsing step is 0.01 to 0.06 mm/min. Preferably, the collapsing process consists of 3 to 5 times of collapsing steps and one closing step and a movement velocity of a torch for heating the tube is set in the range of 2 to 24 mm/min so that the preform tube exhibits so satisfactory surface tension to obtain satisfactory ovality.

Also preferably, the tube is heated so that a temperature of a tube surface becomes 2000 to 2300° C., a difference between inner and outer pressures of the tube is 0 to 10 mm WC, and a movement velocity of the torch is 2 to 24 mm/min.

According to another aspect of the present invention, there is also provided a method for collapsing an optical fiber preform wherein an inner diameter of the hollow preform be kept at a value within the range of 2 to 4 mm just before the closing step through several times of collapsing steps, and then closing step is performed with etching at the same time.

According to the present invention, it is possible to improve ovality and PMD of an optical fiber preform.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a sectional view showing an optical fiber preform having experienced a conventional collapsing process;

FIG. 2 is a sectional view schematically showing a pre-process conducted before a collapsing process according to the present invention in which a deposition layer of soot generation material is formed on an inner wall of a hollow preform;

FIG. 3 is a sectional view showing an optical fiber preform obtained through the preprocess of FIG. 2;

FIG. 4 is a sectional view for illustrating the collapsing process according to an embodiment of the present invention;

FIG. 5 is a flowchart for illustrating the procedure for improving ovality according to the present invention;

FIG. 6 is a sectional view showing a preform obtained through the collapsing process according to the procedure of FIG. 5;

FIG. 7 is a sectional view showing an optical fiber preform having an improved ovality characteristic due to the procedure of FIG. 5;

FIG. 8 a graph for illustrating a change of ovality according to a rate of collapse at each collapsing;

FIG. 9 shows a refractive index dip occurring in the preform after the collapsing process; and

FIG. 10 shows a refractive index of the preform core from which the index dip is eliminated according to the embodiment of the present invention.

### BEST MODES FOR CARRYING OUT THE INVENTION

Hereinafter, preferred embodiments of the present invention will be described in detail with reference to the accompanying drawings.

First, FIG. 2 is a cross sectional view looked downward for illustrating the process of forming a deposition layer of soot generation gas on an inner wall of a hollow preform, as a preprocess of a collapsing process according to the present invention. Referring to FIG. 2, while a tube 10 made of for example quartz glass is rotated at a constant speed in a circumferential direction, soot generation gas 11 such as SiCl₄, GeCl₄ and POCl₃ is injected into the tube 10 together with oxygen. Then, with moving a torch 13 having a semi-cylindrical shape along a longitudinal direction of the tube 10, the tube 10 is heated so that a transparent glass film is deposited on the inner wall of the tube 10. At this time, concentration of the soot generation gas 11 is controlled to adjust a refractive ratio of the deposition layer while a clad/core layer is deposited.

Here, the torch 13 may be changed into various shapes, and for example various heating means such as an oxygen/hydrogen burner and a plasma torch may be adopted.

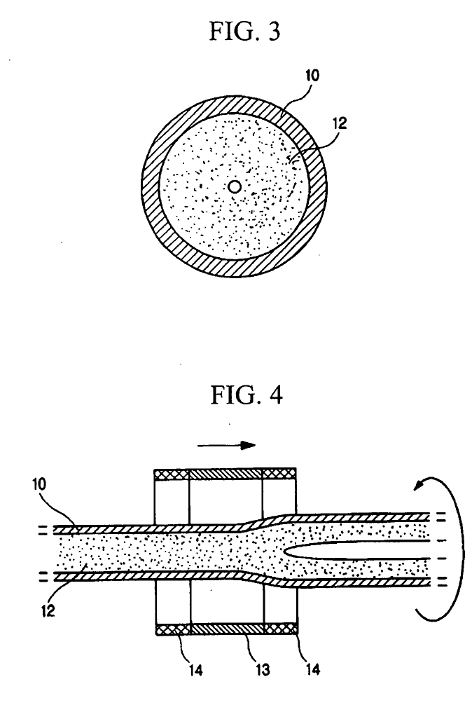

FIG. 3 is a sectional view showing a preform obtained by executing the above process repeatedly just before the tube 10 is clogged. As shown in FIG. 3, a clad/core deposition layer 12 is formed on the inner wall of the tube 10 with a hollow remaining in its center.

And then, a collapsing process is performed to remove an empty space in the tube 10 by condensing the hollow preform as a whole.

FIG. 4 is a schematic sectional view for illustrating the collapsing process. Referring to FIG. 4, with rotating the tube 10 at a constant speed in a circumferential direction, the torch 13 is moved in a longitudinal direction of the tube 10 and at the same time heats the outer surface of the tube 10. Then, a heated portion is condensed and the empty space in the tube 10 is gradually removed.

Here, it is possible to modify the collapsing process so that the tube 10 is moved while the torch 13 is fixed.

In addition, it is also possible to modify the torch 13 to have a ring shape so that the torch 13 heats around the tube 10 without rotating the tube 10.

In the present invention, radiation protection plates 14 made of at least one of SUS, quartz, Al₂O₃ and ZrO₂, which have thermal resistance and oxidation resistance, maybe installed on both sides of the torch 13 so as to reduce thermal radiation loss and thereby improve a rate of collapse.

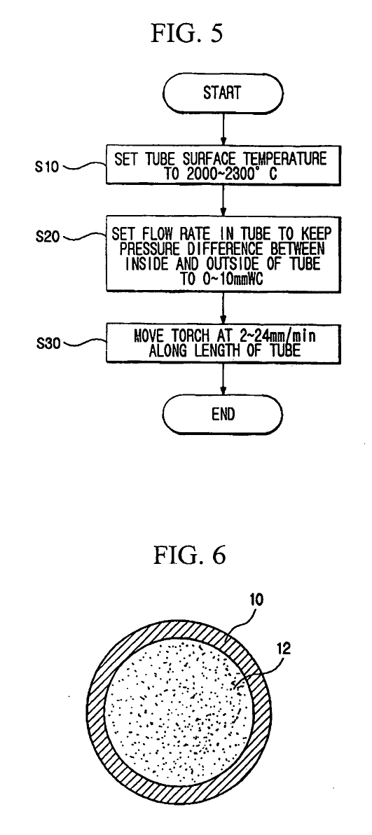

In addition, the present invention may improve ovality of the preform by means of a procedure illustrated in a flowchart of FIG. 5. Referring to FIG. 5, a surface temperature of the tube is firstly set to 2000 to 2300° C. (step S10). At this time, it is possible to prepare a plurality of torches 13 as disclosed in Korean Patent Application Ser. No. 1998-0032447 filed by an applicant of this application in order to enlarge an area of the tube 10 affected by thermal transfer.

Then, a flow rate in the tube is adjusted so that a difference between inner and outer pressures of the tube 10, namely a difference between a pressure caused by temperature or gas flow in the tube 10 and a pressure of a torch flame applied from outside of the tube 10, is kept from 0 to 10 mmWC (step S20). Here, oxygen (O₂) is preferably used for adjusting a flow rate in the tube. In addition, the torch used for heating also generates pressure, and the pressure of the torch flame is determined by the function having factors such as a shape of the torch and a flow rate of gas.

And then, the torch 13 is moved at a velocity of 2 to 24 mm/min along a longitudinal direction of the tube 10, so the tube 10 is subsequently collapsed along its longitudinal direction (step S30).

In order to collapse the hollow preform in which soot is deposited, a surface tension and a difference between inner and outer pressures of the tube are used. A rate of collapse is inversely proportional to the process time. In addition, a rate of collapse is proportional to {the difference between inner and outer pressures+the surface tension}/{viscosity of the tube}. However, since ovality is also proportional to {the difference between inner and outer pressures+the surface tension}/{viscosity of the tube} identically to the rate of collapse, the pressure difference and the tube viscosity should be suitably selected in order to reduce the time required for the collapsing process to the maximum and decrease the ovality of the preform. The viscosity of the tube varies as an exponential function of temperature, and the temperature of the tube is influenced by a thickness of the tube and a heating time, namely a time as long as the torch stays. Thus, a heating temperature and an advancing velocity of the torch, a pressure in the tube should be set in accordance to given thickness of the tube and the deposition layer.

FIG. 8 is a graph showing a change of ovality according to a rate of collapse in case the hollow preform has an outer diameter of 30.5 mm and an inner diameter of 22.5 mm and the deposition layer has a thickness of 5 mm before the collapsing process is executed, as an example.

Referring to FIG. 8, if a rate of collapse at each collapsing step is lower than 0.06 mm/min, the ovality becomes lower than 0.3%. According to the experiments, it is revealed that an optical fiber drawn from a preform having ovality less than 0.3% shows a PMD (Polarization Mode Dispersion) value less than 0.05 ps/nm.●\sqrt{km}.

Values of the ratio of collapse less than 0.01 mm/min at each collapsing step, which shows an extremely low productivity, are not included in the present invention though the ovality is good.

### EXPERIMENTAL EXAMPLE

In this experiment example, the collapsing step is repeated three times under the condition that the tube rotates as much as 20 rpm and main factors such as a difference between inner and outer pressures and a flow rate of oxygen gas in the tube are differently set at each collapsing step as shown in Table 1.

TABLE 1

| | | Difference between | Flow rate of | | |
|---|---|---|---|---|---|
| | Temperature | inner & outer pressures | oxygen gas | Rate of collapse | Ovality |
| | (° C.) | (mmWC) | (sccm) | (mm/min) | (%) |
| 1^{st} | 2000 | 10 | 3000 | 0.05˜0.06 | 0.9 |
| 2^{nd} | 2150 | 5 | 1500 | 0.03˜0.04 | 0.6 |
| 3^{rd} | 2300 | 0 | 20 | 0.01˜0.02 | 0.2 |

The ovality of an optical fiber is improved even though the tube rotates at 30 or 40 rpm.

On the other hand, in order to eliminate or minimize a layer having a refractive index defect in the tube by etching after the collapsing process, an inside surface area of the tube should be minimized so as to prevent GeO₂ from volatilizing. For this reason, a size of the empty area in the tube is made to about 2 to 4 mm after the collapsing steps, namely just before the closing step, thereby minimizing a refractive index defect at the core center.

After making a size of the empty area in the hollow preform into a certain value within 2 to 4 mm through the collapsing steps, the present invention closes the hollow preform together with etching it in order to restrain increase of the inner diameter of the hollow preform due to the etching, thereby minimizing or eliminating a refractive index defect.

In another embodiment of the present invention, a movement velocity of the torch is changed while pressure and temperature in the tube are kept constant so that the inner diameter of the hollow preform is maintained constant. The size of the empty space in the tube is at least 2 mm so as to minimize inferiority in manufacturing the preform and at most 4 mm so that a refractive index dip is not found when drawing an optical fiber.

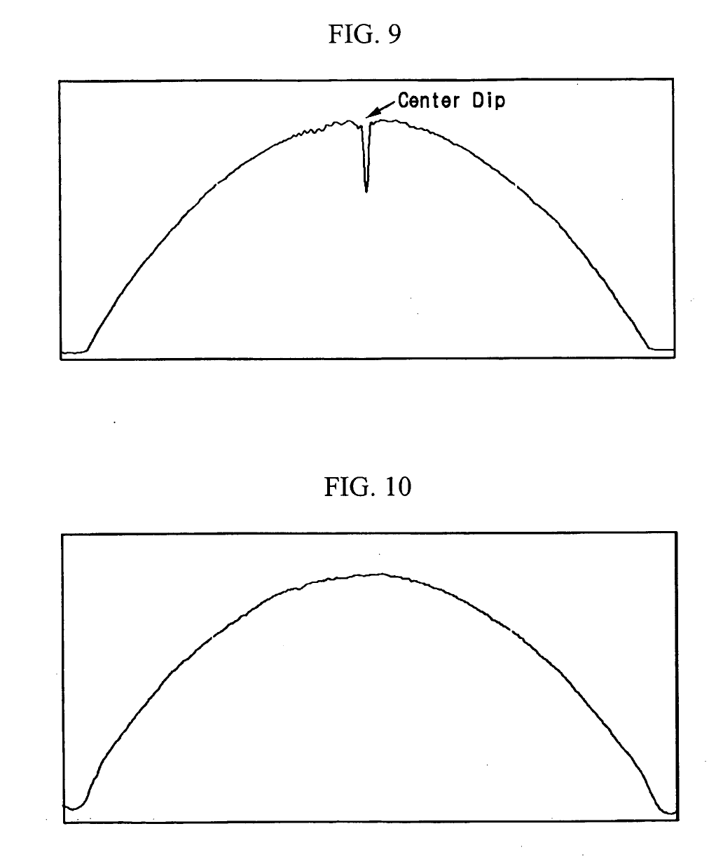

FIG. 10 shows a refractive index at the core center of the optical fiber manufactured according to the embodiment in which an inner diameter of the tube is kept to 2 mm at fourth collapsing step among total five collapsing steps, and then the closing step is executed together with etching with a flow rate ratio (O₂/C₂F₆) of the etching gas being 5.7.

Different from FIG. 9, it is shown in the refractive index graph of the preform core in FIG. 10 that a refractive index defect at the core center is eliminated.

In addition, at the closing step for making a preform rod used for drawing an optical fiber, a small negative pressure as much as −5 to −7.5 mmWC is preferably applied into the tube 10 so that the hollow preform is closed without transforming a geometric structure of the preform.

Furthermore, in the present invention, it is preferable to minimize the difference of inner and outer temperatures of the hollow preform by flowing inert gas having a relatively higher thermal diffusivity into the hollow preform in order to prevent a rate of collapse from decreasing. The inert gas may be selected from He and Ar, as an example.

After passing through the collapsing process as described above, the preform shows a section wherein the clad/core deposition layer 12 is filled in the tube 10 with a satisfactory ovality as shown in FIG. 6, as an example.

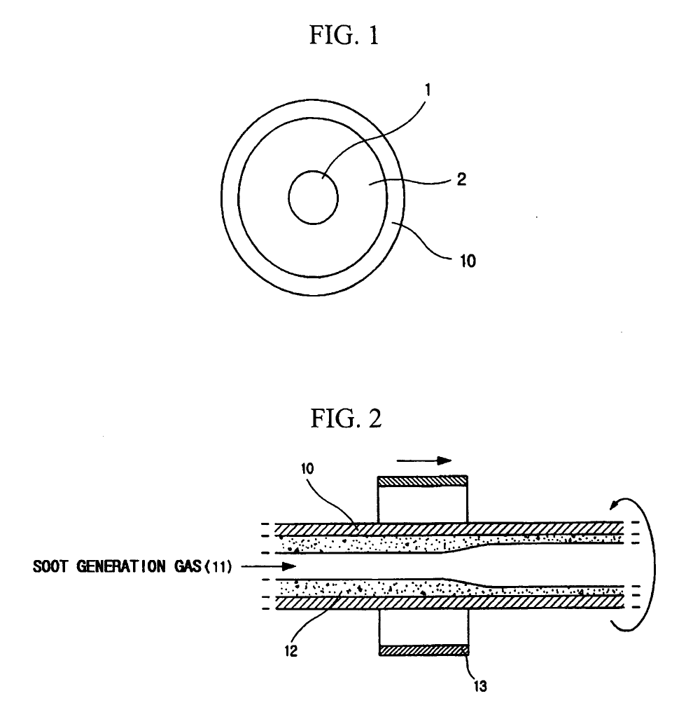

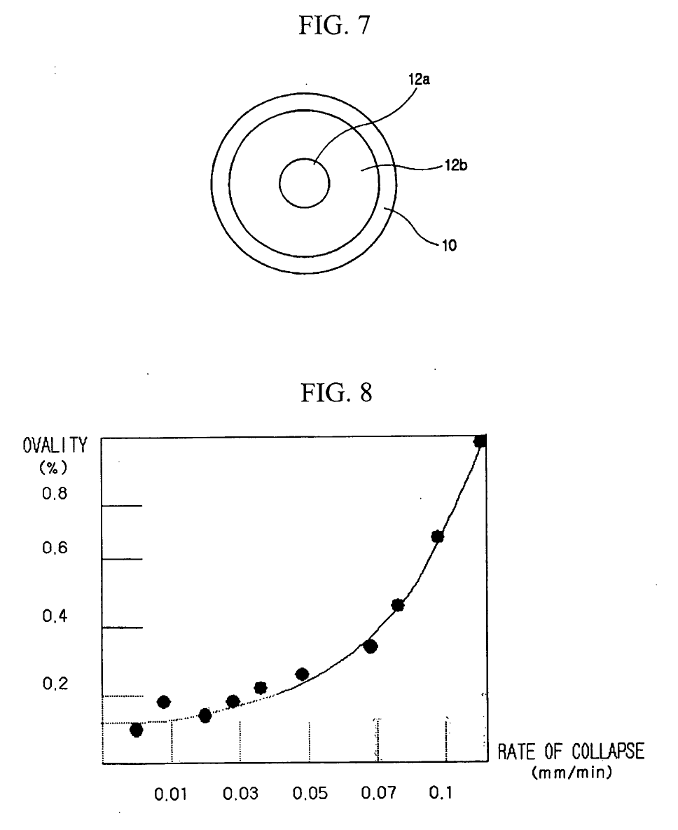

The clad/core deposition layer 12 may be classified into a clad region and a core region depending on the refractive index, which is schematically shown in FIG. 7. Thus, it is possible to obtain an optical fiber preform having excellent ovality, compared with one of FIG. 1.

Industrial Applicability

According to the method for collapsing a hollow optical fiber preform according to the present invention, viscosity and surface tension seriously affecting the geometric structure of the preform during the collapsing process may be optimized by adjusting temperature and pressure applied to the preform.

Therefore, compared with the common values of the prior art showing that ovality is more than 2.0% and PMD is more than 0.05ps/nm●\sqrt{km}, the present invention may improve the ovality less than 0.3% and PMD less than 0.05ps/nmØ\sqrt{km}.

In addition, by using the present invention, a rate of collapse may be increased by flowing gas having a high thermal diffusivity into the tube during the collapsing process.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

1. A method for collapsing a hollow optical fiber preform having a clad/core deposition layer on an inner surface of a hollow preform,
wherein the method comprises a plurality of collapsing steps, and a rate of collapse at each collapsing step is 0.01 to 0.06/mm/min.

2. A method for collapsing a hollow optical fiber preform according to claim 1, further comprising 3 to 5 collapsing steps and one closing step.

3. A method for collapsing a hollow optical fiber preform according to claim 2, wherein the collapsing steps make an inner diameter of the preform to be kept at a value within the range of 2 to 4 mm just before the closing step, and then the closing step is performed.

4. A method for collapsing a hollow optical fiber preform according to claim 3, wherein the closing step is performed concurrently with an etching step.

5. A method for collapsing a hollow optical fiber preform according to claim 3, wherein the closing step is accomplished by applying negative voltage of −7.5 to −5 mm WC to an inside of a preform tube.

6. A method for collapsing a hollow optical fiber preform according to claim 1, wherein a movement velocity of a torch for heating a preform tube is set in the range of 2 to 24 mm/min so that the preform tube exhibits so satisfactory surface tension to obtain satisfactory ovality.

7. A method for collapsing a hollow optical fiber preform according to claim 6, wherein the torch is selected from an oxygen/hydrogen burner and a plasma torch.

8. A method for collapsing a hollow optical fiber preform according to claim 1, wherein, in the collapsing process, a rate of collapse at each collapsing step is determined on the condition that a preform tube is heated so that a temperature of a tube surface becomes 2000 to 2300° C., a difference between inner and outer pressures of the tube is 0 to 10 mm WC, and a movement velocity of the torch is 2 to 24 mm/min.

9. A method for collapsing a hollow optical fiber preform according to claim 8,
wherein the difference between inner and outer pressures of the preform tube is controlled by using gas flowed into the preform tube, and
wherein a flow rate of 0₂ used as the gas flowed into the preform tube is 20 to 3,000 sccm.

10. A method for collapsing a hollow optical fiber preform according to claim 1, wherein a rate of collapse is set differently at each collapsing step.

11. A method for making an optical fiber preform comprising the steps of:
generating a hollow optical fiber preform having at least one clad/core deposition layer on an inner surface of a preform tube;
collapsing the hollow optical fiber preform by heating the preform so that a surface temperature of an outer circumference of the preform becomes 2000 to 2300° C. in order to optimize an inner diameter of the hollow optical fiber preform; and
closing the hollow optical fiber preform by removing an empty space in the hollow optical fiber preform in order to form a preform rod,
wherein a rate of collapse at each of the collapsing step and the closing step is 0.01 and 0.06 mm/min.

12. A method for making an optical fiber preform according to claim 11, wherein the collapsing step is executed 3 to 5 times, and the closing process is executed one time.

13. A method for making an optical fiber preform according to claim 11, wherein a rate of collapse is set differently at each of the collapsing step and the closing step.

14. A method for making an optical fiber preform according to claim 11, wherein, in the collapsing step, a movement velocity of a torch for heating a surface of the hollow preform is 2 to 24 mm/min.

15. A method for making an optical fiber preform according to claim 14, wherein the torch is selected from an oxygen/hydrogen burner and a plasma torch.

16. A method for making an optical fiber preform according to claim 11, wherein, in the collapsing step, a difference between inner and outer pressures of the preform tube is 0 to 10 mm WC.

17. A method for making an optical fiber preform according to claim 12, wherein the collapsing steps make an inner diameter of the preform to be kept at a value within the range of 2 to 4 mm just before the closing step, and then the closing step is preformed.

18. A method for making an optical fiber preform according to claim 17, wherein the closing step is performed concurrently with an etching step.

19. A method for making an optical fiber preform according to claim 17, wherein the closing step is accomplished by applying negative voltage of −7.5 to −5 mmWC to an inside of the preform tube.
